(19) United States
(12) Patent Application Publication
(10) Pub. No.: US 2017/0287078 A9
(43) Pub. Date: Oct. 5, 2017

(54) COMPUTERIZED ACCOUNTING INFORMATION SYSTEM AND A METHOD OF PROCESSING ACCOUNTING DATA

(71) Applicant: Daniel A. Dooley, Hull, GA (US)

(72) Inventor: Daniel A. Dooley, Hull, GA (US)

(21) Appl. No.: 14/593,438

(22) Filed: Jan. 9, 2015

Related U.S. Application Data
(63) Continuation-in-part of application No. 13/560,528, filed on Jul. 27, 2012, now Pat. No. 9,378,026.

(51) Int. Cl. G06Q 40/00

(52) U.S. Cl. CPC G06Q 40/12

(57) ABSTRACT

The present disclosure describes various embodiments, as well as features and aspects thereof, of a computerized accounting information system that comprises a data entry module, a command receiving module and a processing module. The computerized accounting information system configured to receive data entries relating to various transactions and complying with various accounting standard. The present disclosure also describes various embodiments, as well as features and aspects thereof, of a method of processing accounting data that comprises the actions of receiving data entries for a variety of types of data fields that comply with a variety of accounting standards. The described embodiments and aspects provide a computerized accounting information system, and a method of processing accounting data, that can more efficiently and effectively process accounting data entries and that can produce analytical financial accounting actions.

### CROSS-REFERENCE TO RELATED APPLICATION

This application is related to co-pending U.S. utility patent application with application Ser. No. 13/560,528 entitled “CUSTOMIZABLE APPLICATION,” filed on Jul. 27, 2012, and having attorney docket number 20071.1010, which is entirely incorporated by reference herein.

### BACKGROUND

The present disclosure relates to a system and method for data management and, more particularly, to an improved computerized accounting information system and a method of processing accounting data.

The significant advancements in data measurement and collection of the past century have made obtaining relevant and competent data relatively easy and inexpensive. Despite the obvious benefits, one result of this copious data intake is the creation of a new burden on data collectors. It is well known that data is worthless if it is not organized in a manner that allows the data collector to distill meaning, extrapolate inferences, and find pertinent data effectively and efficiently. Consequently, data management software has become a ubiquitous tool for holding, organizing and facilitating the analysis of vast amounts of data.

Data management software generally takes the form of a digital database that stores discrete datum points, organizes the datum points into fields (to distinguish certain types of datum from other types of datum) and provides analytical tools (e.g., arithmetic and statistical) for the analysis of the data. Data management software may have many other additional features.

In particular, data management software is very beneficial for the field of financial accounting, which relies heavily on analyzing vast amounts of financial accounting data. Financial accounting data is generally vast because of the nature of the accounting practice itself. Accounting relies on a thorough collection and analysis of all transactions over a fixed period of time. A plurality of different financial documents, based on the accounting data, tell the financial story of a financial entity over that period of time and provide insight into how the financial entity is doing (as compared to the past) and how the financial entity is projected to do in the future (based on data previously collected). This story includes an assessment of the cash flows, debts, accounts receivable, liabilities, equities, incomes, losses, taxes, etc. In the end, the plurality of different financial documents must be reconciled so as to make sure that there are no missing/incorrect points of datum, which could skew any analysis results, and that all applicable laws governing financial accounting have been followed. This is where the data management software becomes most useful.

However, financial accounting data is especially unique in that it is typically a combination of empirical information (e.g., monetary values and tax percentages) and non-empirical judgment characterizations. For example, a financial accountant compiling financial accounting data for a specific financial entity must generally follow a specific accounting standard for each jurisdiction in which they have to produce financial documents. The reason being that many jurisdictions (typically, different nation-states) have different tax rates, different laws governing the characterizations of different financial transactions and, sometimes, different generally accepted accounting principles. Therefore, even though the same empirical information is coming into the data management software, that empirical information may be characterized differently by the financial accountant depending on the particular accounting standard being followed. As a result, presently available data management software continues to remain useful for the financial accountant but it is significantly less useful than in other fields for the following two reasons.

First, because of the different accounting principles, a financial accountant must generally use different and discrete data management software records for each accounting principle governing the characterization of that financial entity's accounting data. Second, to go along with each of these different and discrete data management software records, the financial accountant must generally keep a log of the rational behind the judgment characterizations made by the financial accountant under each accounting standard. This log is needed because it is difficult for the financial accountant to keep track of each specific judgment characterization for each specific accounting standard for each specific datum point. Moreover, it is not uncommon for the jurisdictions to make significant changes to the accounting standards throughout the life of a financial entity. This results in financial accounting data records for a specific financial entity wherein one range of data records under a specific accounting standard have different rationales for the judgment characterizations than another range of data records under that same specific accounting standard.

Consequently, because of the stated significant deficiencies in presently available data management software, there is a need in the art for an improved computerized accounting information system and a method of processing accounting data.

### SUMMARY

The present disclosure describes various embodiments, as well as features and aspects thereof, of a computerized accounting information system. More specifically, one non-limiting embodiment of a computerized accounting information system comprises a data entry module, a command receiving module and a processing module. The processing module communicatively coupled to the data entry module and the command receiving module and configured to receive a data entry from the data entry module wherein the data entry is relating to a first transaction and wherein the data entry complies with a default accounting standard. The processing module is additionally configured to receive a data entry from the data entry module wherein the data entry is relating to a second transaction and wherein the data entry complies with the default accounting standard and a non-default accounting standard. The processing module additionally configured to receive a command from the command receiving module wherein the received command is requesting an action to be performed and wherein the received command is identifying an accounting standard. The processing module additionally configured to perform the action identified in the command based, at least in part, on the identified accounting standard. The processing module performing the action is such that if the identified accounting standard is the default accounting standard then the processing module utilizes one or more data entries that comply with the default accounting standard. However, the processing module performing the action is such that if the identified accounting standard is the non-default accounting standard then the processing module utilizes one or more data entries that comply with the non-default accounting standard, if available. Otherwise, the processing module utilizes data entries that comply with the default accounting standard for each of the one or more data entries that is unavailable in the non-default accounting standard.

The present disclosure also describes various embodiments, as well as features and aspects thereof, of a method of processing accounting data. More specifically, one non-limiting embodiment of a improved method of processing accounting data comprises the actions of receiving a data entry for a first type of data field, wherein the data entry complies with a default accounting standard. The method of processing accounting data additionally comprises the actions of receiving a data entry for a second type of data field, wherein the data entry complies with the default accounting standard and at least one other accounting standard. The method of processing accounting data additionally comprises the actions of receiving a command to perform an action, the command identifying an accounting standard. Now, if the identified accounting standard is the default accounting standard then performance of the action utilizes one or more data entries that comply with the default accounting standard. But, if the identified accounting standard is the at least one other accounting standard then performance of the action utilizes one or more data entries that comply with the at least one other accounting standard, if available. Otherwise, performance of the action utilizes a data entry that complies with the default accounting standard for each of the one or more data entries that is unavailable in the at least one other accounting standard.

Various embodiments, configurations, features and aspects of the computerized accounting information system and the method of processing accounting data are described in more detail in the detailed description with reference to the attached drawings.

### BRIEF DESCRIPTION OF THE SEVERAL VIEWS OF THE DRAWING

FIG. 1 is a functional block diagram of the components of an exemplary environment or platform in which various embodiments of a computerized accounting information system and a method of processing accounting data may be implemented.

FIG. 2 is a functional block diagram of platform 100 of FIG. 1 implemented with one non-limiting embodiment of a computerized accounting information system 200 and accessible by one non-limiting embodiment of an end-user platform 205.

FIG. 3 is a flowchart diagram illustrating a first set of actions that may be implemented by the various embodiments of the computerized accounting information system of the present disclosure, or that may be included within a method of processing accounting data.

FIG. 4 is a flowchart diagram illustrating a second set of actions that may be implemented by the various embodiments of the computerized accounting information system of the present disclosure, or that may be included within a method of processing accounting data.

FIG. 5 is a flowchart diagram illustrating a third set of actions that may be implemented by the various embodiments of the computerized accounting information system of the present disclosure, or that may be included within a method of processing accounting data.

FIG. 6 is a flowchart diagram illustrating a fourth set of actions that may be implemented by the various embodiments of the computerized accounting information system of the present disclosure, or that may be included within a method of processing accounting data.

FIG. 7 is a flowchart diagram illustrating a fifth set of actions that may be implemented by the various embodiments of the computerized accounting information system of the present disclosure, or that may be included within a method of processing accounting data.

FIG. 8 is a flowchart diagram illustrating a sixth set of actions that may be implemented by the various embodiments of the computerized accounting information system of the present disclosure, or that may be included within a method of processing accounting data.

FIG. 9 is a flowchart diagram illustrating a seventh set of actions that may be implemented by the various embodiments of the computerized accounting information system of the present disclosure, or that may be included within a method of processing accounting data.

FIG. 10 is a screenshot of one non-limiting embodiment of an end-user interface 1000 as it might appear to an end-user.

### DETAILED DESCRIPTION OF VARIOUS EMBODIMENTS

The following written description explains various embodiments of a computerized accounting information system and a method of processing accounting data. Various embodiments, as well as features and aspects that may be incorporated into some embodiments, are presented in this description. In general, some embodiments may be direct towards an accounting system, or other data entry system that allows a user to enter data based on multiple criteria—such as different accounting standards. The user can thus keep track of multiple transactions entered in compliance with different accounting standards. In addition, reports, analysis or other actions can be performed with this single accounting system, based on any of the accounting standards supported by the data entry.

This written description refers to the appended drawings to supplement the written explanation. As such, the written words should not be construed as limitations. Numerous specific details are explained in the written description and depicted in the drawings to provide an enabling understanding of the various embodiments to one having ordinary skill in the art. Some details, however, need not be expressly explained because they would be readily apparent and understood by one having ordinary skill in the art. For example, certain described embodiments and explanations of some specific details are omitted so as to not unnecessarily obscure the written description. Additionally, one having ordinary skill in the art would understand that the various embodiments might be practiced without some or all of these specific details.

Although throughout the detailed description the various embodiments are directed towards a computerized accounting information system and a method of processing accounting data, it should be understood that the focus of such description is only to ensure clarity in the configuration and operation of the various embodiments. The description should not be used to limit the usefulness of the various embodiments in other manners or for other uses.

Embodiments and aspects of the present invention provide a computerized accounting information system, and a method of processing accounting data, that can more efficiently and effectively process accounting data entries, for various types of data fields, that comply with various accounting standards and produce analytical accounting actions. More specifically, the system or method is configured to give an end-user quick and simple access to accounting data entries, which have been characterized by various accounting standards, without the need for disparate data records or out-of-system explanatory logs for the accounting standard characterizations. Furthermore, the system or method is configured to leverage these data entries produce accounting standard specific analytical accounting actions that include the production of reports, tax returns and other similar financial statements known to one having ordinary skill in the art.

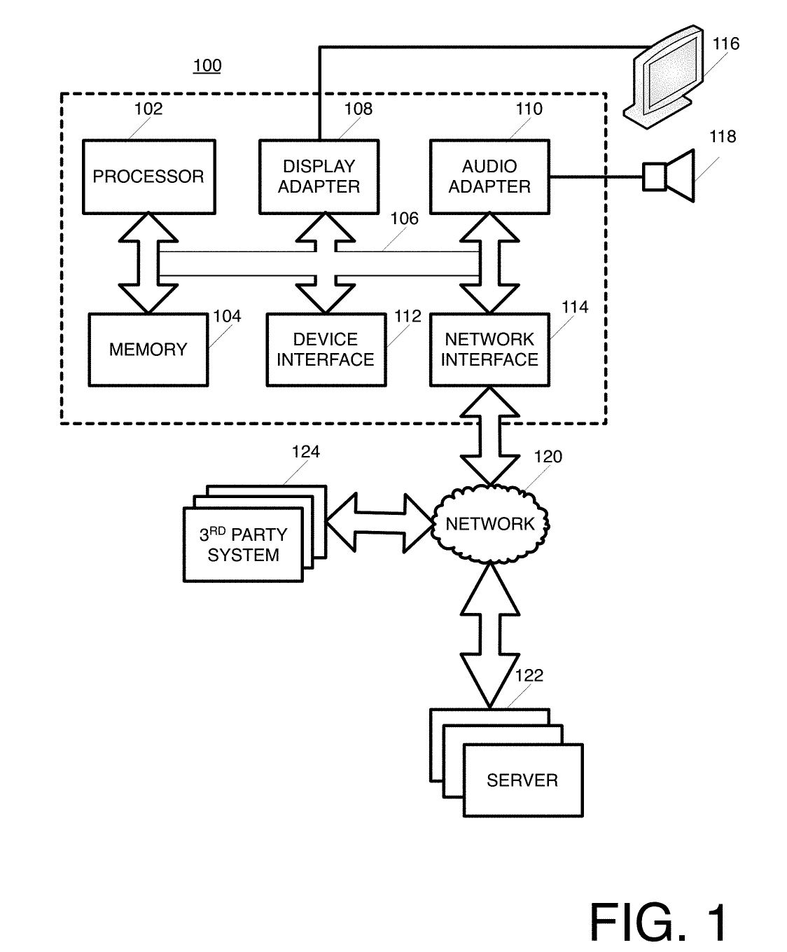

Turning now to the figures, FIG. 1 is a functional block diagram of the components of an exemplary environment or platform in which various embodiments of a computerized accounting information system and a method of processing accounting data may be implemented. It will be appreciated that not all of the components illustrated in FIG. 1 are required in all embodiments or implementations of the system or method, but each of the components are presented and described in conjunction with FIG. 1 to provide a complete and overall understanding. In addition, it will be appreciated that the embodiments of the system or method may be implemented in environments and/or platforms that may include other components and functionality. Therefore, the illustrated configuration is simply a non-limiting example.

The exemplary platform 100 is illustrated as including a processor 102 and a memory element 104. In some embodiments, the processor 102 and the memory element 104 may be communicatively coupled over a bus or similar interface 106. In other embodiments, the processor 102 and the memory element 104 may be fully or partially integrated with each other. The processor 102 may be any of a variety of processor types including microprocessors, micro-controllers, programmable arrays, custom ICs, etc., and may also include single or multiple processors with or without accelerators, or the like.

The memory element of 104 may include any of a variety of structures, including but not limited to RAM, ROM, magnetic media, optical media, bubble memory, FLASH memory, EPROM, EEPROM, etc. In addition, rather than being internal to the platform 100, the memory element 104 may be external to the platform 100 and accessed through a device interface 112 or a network interface 114.

The processor 102, or the other components of the platform 100, may also provide sub-components or functionalities such as a real-time clock, an analog-to-digital convertor, a digital-to-analog convertor, sensors, etc. The processor 102 may also interface to a variety of elements including a control/device interface 112, a display adapter 108, an audio adapter 110 and a network/device interface 114.

The control/device interface 112 may provide an interface to external devices, systems, equipment, sensor, actuators or the like. As non-limiting examples, the control/device interface 112 may be used to interface with devices or systems such as a keyboard, a mouse, a pin pad, an audio activate device, a gaming console, a gesture recognition sensor, an accelerometer, any other computer or processing device, as well as a variety of many other available input and output devices.

The display adapter 108 may be used to drive a variety of visually oriented elements 116, such as a display device including an LED display, LCD display, a Plasma display, a 3-D/holographic/virtual-reality display, one or more LEDs or other display devices, printers, etc. The audio adapter 110 may interface to and drive a variety of audible or other alert elements 118, such as a speaker, a speaker system, a buzzer, a bell, a vibrator, etc.

The network/device interface 114 may also be used to interface the platform 100 to any of a variety of other electronic devices or systems through a network 120. The network 120 may be a local network, a wide area network, a wireless network (WIFI, Bluetooth, cellular, 3G, LTE etc.), a global network such as the Internet, or any of a variety of other configurations including hybrids, etc. The network/device interface 114 may be a wired interface or a wireless interface.

The platform 100 is shown in FIG. 1 as interfacing to a server 122 and a third party system 124 through the network 120. Thus, the platform 100 may function independently, in connection with one or more systems, or even as a distributed system. It is envisioned that a battery or a power source provides power for the platform 100.

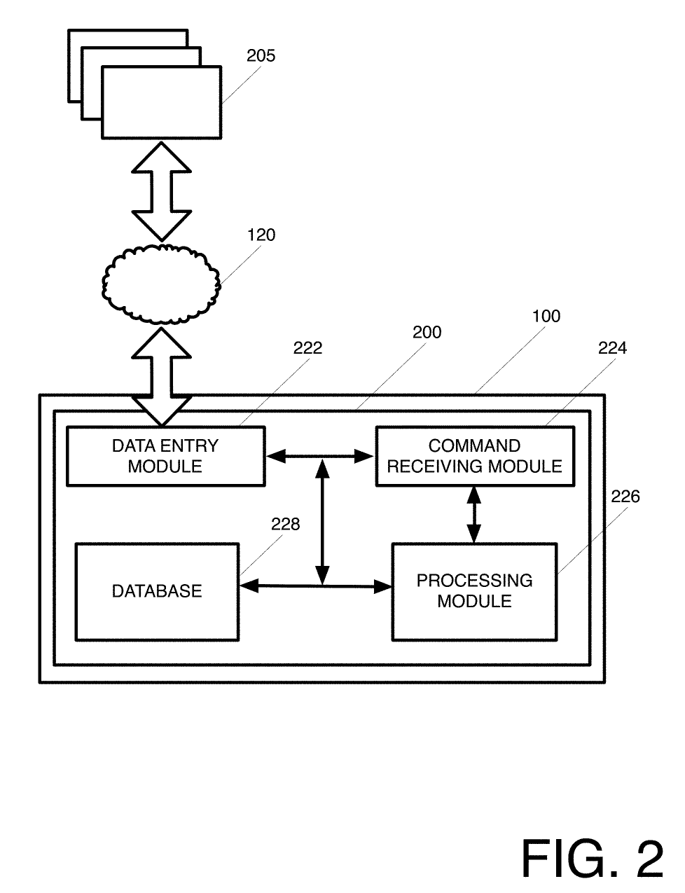

FIG. 2 is a functional block diagram of one non-limiting embodiment of a computerized accounting information system. The computerized accounting information system 200 may be implemented on a platform such as the platform 100 of FIG. 1. Furthermore, the computerized accounting information system 200 may be accessible by one non-limiting embodiment of an end-user platform 205. The computerized accounting information system 200 is comprised of a data entry module 222, a command receiving module 224, a processing module 226 and a database 228. However, the computerized accounting information system 200 may be comprised of various other modules or components providing any of a variety of functionalities not necessarily described in the following disclosure.

As should be understood by one having ordinary skill in the art, these components are communicatively coupled and may be dispersed throughout the architecture of the platform upon which the computerized accounting information system 200 is implemented. Furthermore, these components may be substantially discrete or may have considerable overlap, e.g., in terms of where, when and how they are stored, processed and operated. Therefore, FIG. 2's representation of these components as separate and distinct modules is merely for ease of description and visual representation and is not intended as a limitation or as the actual physical construction of the computerized accounting information system 200.

Moreover, in some non-limiting embodiments, the end-user platform 205 is a data input device, or the like, that interfaces with the control/device interface 112 of the platform 100. Therefore, the end-user platform 205 may simply be an additional component of the platform upon which the computerized accounting information system 200 is implemented. On the other hand, the end-user platform 205 may exist as an entirely distinct environment or platform from the environment or platform upon which the computerized accounting information system 200 is implemented. Therefore, end-user platform 205 may be similarly configured as platform 100 of FIG. 1. As a result, it is envisioned that the end-user platform 205 may be communicatively coupled to a control/device interface, network interface, or any other similar component, through a network, or through any other applicable wired or wireless communications channel.

Moreover, in some non-limiting embodiments, the data entry module 222 functions, at least in part, as an interface point between the end-user platform 205 and the computerized accounting information system 200. The data entry module 222 having the purpose of receiving, digitally storing and organizing the data entries from the end-user. Consequently, the data entry module 222 is configured to provide the end-user with the ability to label, categorize and/or organize data entries into fields (e.g., debits, credits, cash-flows in, cash-flows out, accounts receivable, liabilities, equity assets, capital assets, cash, debt, taxes). Furthermore, the data entry module 222 is additionally configured to aggregate data entries of different fields into over-arching transactions (e.g., the debits and credits involved with the sale of an asset as part of transaction 1 as distinct from the debits and credits involved with the acquisition of an asset as part of transaction 2). Furthermore, the data entry module 222 is additionally configured to provide the end-user with the ability to specify the accounting standard (e.g, U.S.A G.A.A.P., U.K. G.A.A.P, Plan Comptable General of France, Grundsätze ordnungsmäβiger Buchführung of Germany, Chinese Accounting Standards of China and International Financial Reporting Standards) by which the data entries are characterized.

Because of the various physical locations wherein the data entry module 222 can be implemented, the data entry module 222 may take the form of a user-interface that is accessible remotely from the end-user platform 205 through a network, a wired connection, a wireless connection, etc. (e.g., stored in the cloud and accessed as online application or stored on a server and accessed through a webpage). Furthermore, the data entry module 222 may take the form of a packaged software bundle, or any downloadable piece of software known to one having ordinary skill in the art, that is implemented directly on the end-user platform 205 and which communicates with the other components of the computerized accounting information system 200.

Moreover, in some non-limiting embodiments, the database 228 functions, at least in part, as the short-term or long-term storage for data entries received by the data entry module 222. The database 228 may be configured as a read-write medium capable of being accessed by the computerized accounting information system 200 or any other platform/system/software/module with need for the information stored therein. Therefore, the database 228 may be formatted to any standard known to one having ordinary skill in the art. Furthermore, the database 228 may be read and updated in real time by the data entry module 222 such that the user-interface can illustrate data entries, with their associated categorical/organizational/accounting standard metadata, that have been previously received by the computerized accounting information system 200. This function essentially allows the data entry module 222 to act as a browser for the information stored on the database 228.

Moreover, in some non-limiting embodiments, the command receiving module 224 functions, at least in part, as an interface point for receiving a command to invoke an action within the computerized accounting information system 200. The received command may also identify the accounting standard pertinent to the desired action. The action invoked by the command may be any type of analytical accounting action, e.g., the production of reports, tax returns and other similar financial statements, that involves, at least in part, searching, compiling, discriminating, comparing and/or extrapolating meaning from the relevant data set. Consequently, the command receiving module 224 may be integrated, partially or fully, with data entry module 222 such that an end-user may specify the command directly within the user-interface. It is also envisioned that the command receiving module 224 may be stand-alone and capable of receiving the command, either pre-programmed or real-time selected, from other systems/platforms/environments.

Moreover, in some non-limiting embodiments, the processing module 226 is configured to receive the data entries from the data entry module 222 and the command from the command receiving module 224 and perform the identified action. Because the command may also identify the account standard pertinent to the desired action, performance of the action by processing module 226 may be based, at least in part, on the identified accounting standard. As a result, the processing module 226 is configured to access the database 228 to leverage any other pertinent data entries previously received by the computerized accounting information system 200. The processing module 226 may also be configured to alert the end-user, at least in part, through the user-interface of the data entry module 222, if a data entry has not been received but that is needed for performance of the action. One having ordinary skill in the art should know that there are various methods and techniques for alerting an end-user that involve or do not involve the user-interface of the data entry module 222.

Because data entries may be labeled, categorized and/or organized into sub-fields and then aggregated into over-arching transactions, the processing module 226 may also be configured to recognize those sub-fields and to recognize those transactions most relevant to the identified action and the identified accounting standard in the command. Therefore, the processing module 226 may employ a smart logic to selectively search, filter and/or compile data entries for performing the identified action.

The processing module 226 may also be configured to analyze the data entries presently entered into the data entry module 222 (but not yet stored in the database 228) or the data entries previously received and stored in the database 228 (but not presently entered into the data entry module 222) for significant deviations from what would be expected as a consistent data entry under a particular accounting standard. Therefore, the processing module 226 may infer/extrapolate/compute this expected data entry based, at least in part, on a sample of related and relevant data entries under a similar transaction, or under a similar sub-field across a variety of transactions. The processing module 226 may provide an alert indicator if the data entries significantly deviate from the expected data entry. Additionally, the processing module 226 may be configured to prepopulate the data entry module 222 with a suggested place holder data entry (derived from the expected data entry) if the presently entered data entry significantly deviates from the expected data entry. This suggestion is intended to help guide the end-user to realize any possible mistakes in their data or in their characterization of the data using the intended accounting standard.

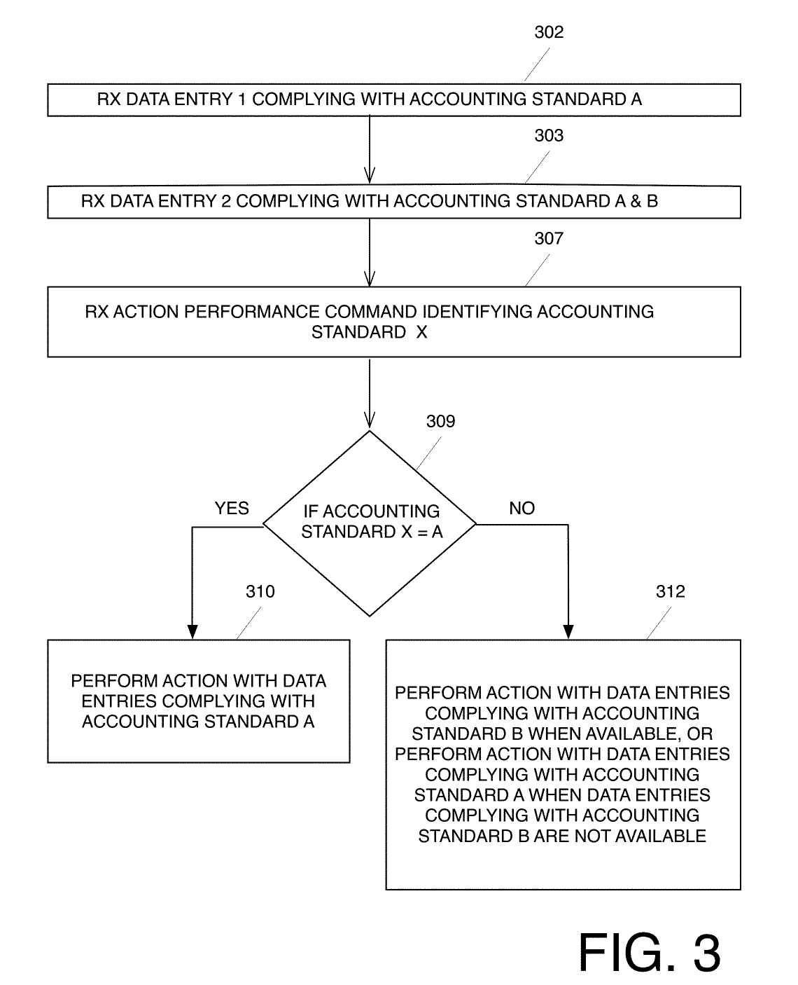

FIG. 3 is a flowchart diagram illustrating actions that may be implemented by some embodiments of the computerized accounting information system, or that may be included within a method of processing accounting data. While these actions may be presented in particular order, a person having ordinary skill in the art understands that this order is merely for ease of description and, therefore, is not intended as a limitation.

Initially, data for a first type of data field (e.g., debit, credit, cash-flow in, cash-flow out, account receivable, liability, equity asset, capital asset, cash, debt, tax) is entered into the computerized accounting information system. This can be done in a variety of manners such as reading data from a file, receiving a download of data, receiving individual data inputs, or any other manners known by one having ordinary skill in the art. Overall, a data entry for a first type of data field is received wherein the data complies with at least a default accounting standard, “A” (302). A data entry for a second type of data field is also received wherein the data complies with the default accounting standard “A” and at least one other accounting standard “B” (303). Multiple other data entries may also be received, and these other data entries may each comply with a variety of permutations of accounting standards for a particular type of data field. In one class of embodiments, all the data entries at least comply with the default accounting standard. However, other classes of embodiments may not impose this restriction.

Any received data entry may be stored in the database 228 for later access or they may be received and used without storage. Therefore, regardless of whether the data entries will be stored or received-used-discarded, Table 1a is intended to depict, as a non-limiting embodiment, how received data entries may be compiled and organized for use directly from the end-user or pulled from a database. For purposes of Table 1 a, the “Data Entry ID” identifier, e.g., 1, 2, 3, is intended to differentiate between different data entries. The triplet letter designation, e.g., XXX, YYY, is intended to differentiate between the different types of data fields. The “Accounting Standard” identifier, e.g., [none], ′, ″, on the triplet letter designation is intended to differentiate between the different accounting standards by which the data entries may comply.

TABLE 1a

| Data | Accounting Standard | | |
|---|---|---|---|
| Entry ID | A | B | C |
| 1 | XXX | | |
| 2 | YYY | Y′Y′Y′ | |
| 3 | ZZZ | Z′Z′Z′ | |

Therefore, Table 1a depicts that “Data Entry ID” 1 for a first type of data field (e.g., cash-flow out) was received, and that this data entry complied with the “A” accounting standard. Table 1a also depicts that “Data Entry ID” 2 for a second type of data field was received (e.g., cash-flow in) and this data entry complied with the “A” accounting standard and at least one other accounting standard; specifically, the “B” accounting standard. Table 1a also depicts that “Data Entry ID” 3 for a third type of data field was received (e.g., account receivable) and this data entry complied with the “A” accounting standard and at least one other accounting standard; specifically, the “B” accounting standard.

After the data has been entered into the system, a command to perform an action is received. The command may also identify one or more accounting standards for performance of the action or, in the absence thereof, the default accounting standard may be assumed. Other information or instructions for performance of the action, or the like, may also be included with the command (307).

Thus, the command is basically a request to perform an action. The action is to be influenced or based, at least in part, on the identified accounting standard or standards. If the identified accounting standard is the “A” accounting standard (309), then the action of the command is performed with one or more data entries that comply with the “A” accounting standard (310). However, if the identified accounting standard is the “B” accounting standard (309), then the action of the command is performed with one or more data entries that comply with the “B” accounting standard, if available (312). If not available, then the action of the command is performed with one or more data entries that comply with the “A” accounting standard for each of the one or more data entries that is unavailable in the “B” accounting standard (312).

It should be appreciated that Table 1a illustrates a simplified structure and that, in practice, the structure may be more complex in nature. For example, a data entry for a type of data field may be more complex than merely an entry into one “field” as seemingly illustrated by the triplet letter designation in Table 1a. Instead, the data entry may be into one or more fields represented by the triplet letter designation; the one or more fields based, at least in part, on the applicable accounting standard characterizing that specific data entry. For instance, consider a situation in which a law firm receives a single check from a specific client for a specific legal service provided (i.e. one specific cash-flow in). This specific check constitutes one specific data entry, for example, “Data Entry ID” 2 of Table 1a. If the applicable accounting standard characterizing “Data Entry ID” 2 is the “A” accounting standard, a portion of the check total amount may be allocated to a variety of fields represented by the triplet letter designation YYY: one third to “over head cost recoupment,” one third to “origination fee allocation” and one third to “firm income.” However, if the applicable accounting standard characterizing “Data Entry ID” 2 is the “B” accounting standard, the entire check total amount may be allocated to one field represented by the triplet letter designation YYY: “firm income.” Similarly, if the applicable accounting standard characterizing “Data Entry ID” 2 is the “C” accounting standard, the entire check total amount may be allocated to a variety of fields represented by the triplet letter designation YYY: one fourth to “business development cost recoupment,” one fourth to “origination fee allocation,” one fourth to “management cost recoupment” and one fourth to “firm income.”

Table 1b depicts, as a non-limiting embodiment, how received data entries such as those of the law firm example may be compiled and organized for use directly from the end-user or pulled from a database. For purposes of Table 1b, the “Field ID” identifier, e.g., 1, 2, 3, is intended to differentiate between different fields in which data may be entered for the specific “Data Entry ID” 2 depending on the applicable accounting standard. Specifically, “Field ID” 1 is “over head cost recoupment,” “Field ID” 2 is “origination fee allocation,” “Field ID” 3 is “firm income,” “Field ID” 4 is “business development cost recoupment” and “Field ID” 5 is “management cost recoupment.”

TABLE 1b

| | Data Entry ID 2 | | |
|---|---|---|---|
| FIELD ID | YYY | Y′Y′Y′ | Y″Y″Y″ |
| 1 | 1/3 | — | — |
| 2 | 1/3 | — | 1/4 |
| 3 | 1/3 | 1/1 | 1/4 |
| 4 | — | — | 1/4 |
| 5 | — | — | 1/4 |

Therefore, Table 1b depicts the various ways in which the total value of the client check to the law firm, “Data Entry ID” 2, may have been entered/distributed into the computerized accounting information system. If “Data Entry ID” 2 complied with the “A” accounting standard, then a data entry for Field ID” 1, “Field ID” 2 and “Field ID” 3 was received. If “Data Entry ID” 2 complied with the “B” accounting standard, then a data entry for Field ID” 3 was received. If “Data Entry ID” 2 complied with the “C” accounting standard, then a data entry for Field ID” 2, “Field ID” 3, “Field ID” 4 and “Field ID” 5 was received.

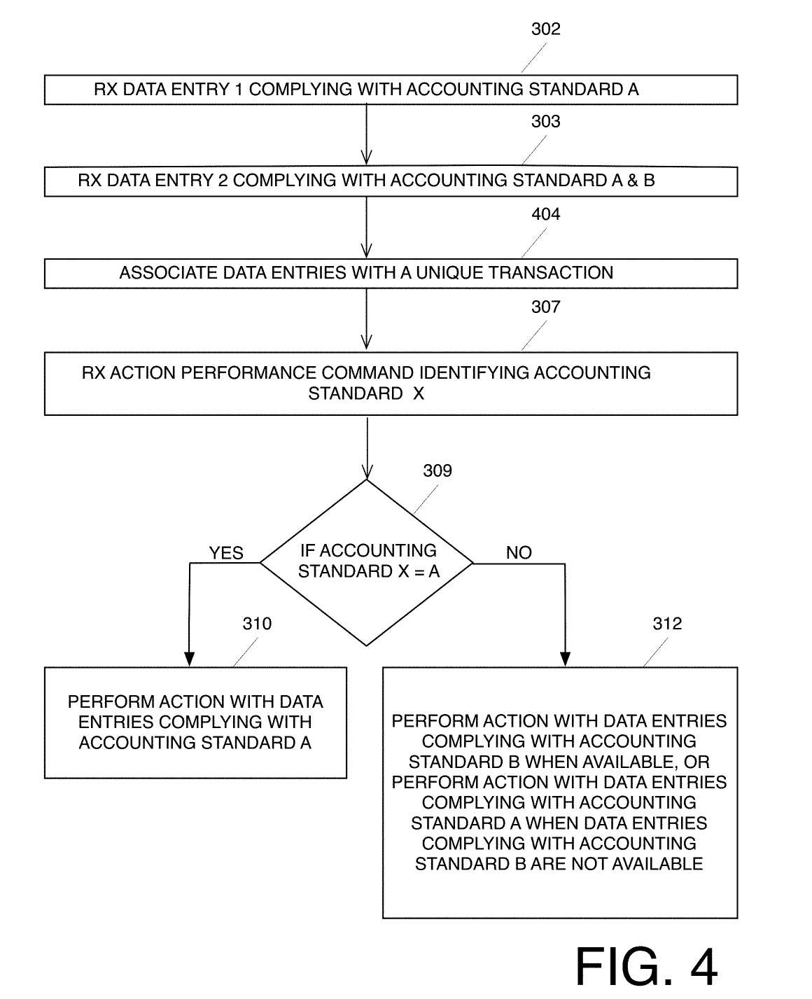

FIG. 4 is a flowchart diagram illustrating actions that may be implemented by some embodiments of the computerized accounting information system, or that may be included within a method of processing accounting data. Specifically, FIG. 4 is the flowchart diagram of FIG. 3 with an additional action.

As is described above, the data entries may be labeled, categorized and/or organized into individual fields of data (e.g., debit, credit, cash-flow in, cash-flow out, account receivable, liability, equity asset, capital asset, cash, debt, tax). The data entries of different individual types of fields of data may also be aggregated into over-arching transactions (e.g., the debits and credits involved with the sale of an asset as part of one specific transaction as distinct from the debits and credits involved with the acquisition of an asset as part of an entirely distinct transaction). Therefore, multiple data entries for the same type of data field may be received by the computerized accounting information system for various different unique transactions.

For instance, consider the previously described situation wherein the law firm received a single check from a specific client for a specific legal service provided (i.e. one specific cash-flow in). It is possible that this one specific cash-flow in (one type of data field) may be part of a larger over-arching transaction that involves certain cash-flows out, certain accounts receivable owed by the client to the law firm, etc. While the specific check may constitute one specific data entry, for example “Data Entry ID” 2 of Table 1a, the account receivable owed by the client to the law firm may constitute another specific data entry, for example “Data Entry ID” 3 of Table 1a. It is possible that these two data entries may be received together as one aggregate unique transactional data entry representing the larger financial transactions between the law firm and the client. It also possible that an entirely different client has a similar accounting transactions with the law firm that similarly involves that same types of data fields, e.g., a cash-flow into the firm, in terms of a received payment check, and an account receivable owed by this client to the firm. Like the first client, it is possible that the larger over-arching financial transaction may be received as one aggregate unique transactional data entry representing the larger financial transaction between the law firm and this second client.

As a result, in FIG. 4, a data entry for a unique transaction into the computerized accounting information system may not merely encompass data for one type of data field, e.g., only XXX or only YYY or only ZZZ; instead, a data entry may encompass data for multiple types of data fields, e.g., XXX and YYY and/or ZZZ. Therefore, in order to distinguish between sub-categories of data in the received data entries, e.g., “Data Entry ID” 1, “Data Entry ID” 2, the data entries were associated with the unique transaction (404).

Table 2 depicts, as a non-limiting embodiment, how received data entries for unique transactions may be compiled and organized for use. For purposes of Table 2, the triplet letter designation, e.g., ααα, βββ, is intended to differentiate between different unique transactions. As a result, Table 2's triplet greek letter designation may encompass one or more sub-categories of data for any type of data field, e.g., XXX, YYY, ZZZ. Like Table 1a, the “Accounting Standard” identifier, e.g., [none], ′, ″, on the triplet letter designation is intended to differentiate between the different accounting standards by which the data entries, and any of their sub-categories of data, may comply.

TABLE 2

| Data | Accounting Standard | | |
|---|---|---|---|
| Entry ID | A | B | C |
| 1 | ααα | | |
| 2 | βββ | β′β′β | |

Therefore, Table 2 depicts that “Data Entry ID” 1 for the ααα unique transaction (e.g, the transaction related to the first law firm client) was received and that this data entry, and all of its sub-categories of data, complied with the “A” accounting standard. Table 2 also depicts that the “Data Entry ID” 2 for the βββ (e.g., the transaction related to the second law firm client) was received and that this data entry, and all of its sub-categories of data, complied with the “A” accounting standard and the “B” accounting standard. One having ordinary skill in the art should understand that the description of Table 2 is equally applicable to data entries for unique transactions and/or any of their sub-categories of data.

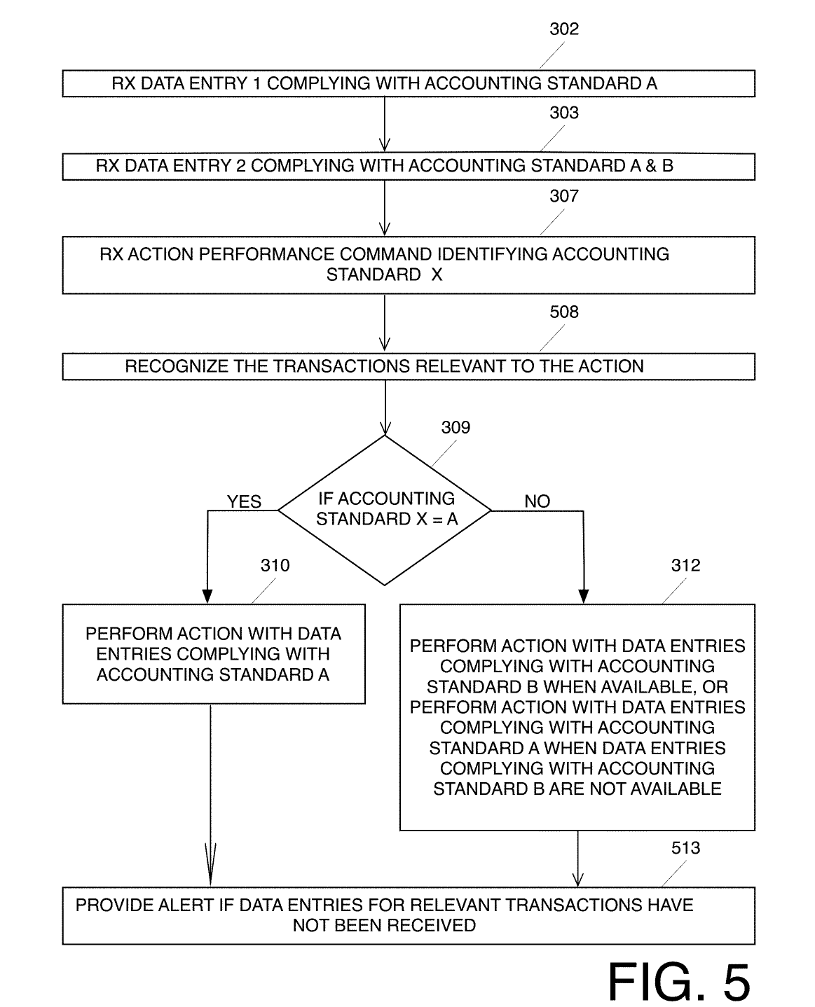

FIG. 5 is a flowchart diagram illustrating actions that may be implemented in some embodiments of the computerized accounting information system, or that may be included within a method of processing accounting data. Specifically, FIG. 5 is the flowchart diagram of FIG. 3 with additional actions.

As is described above, because data entries may be labeled, categorized and/or organized into sub-fields and then aggregated into over-arching transactions, it is envisioned that it is possible to leverage a smart logic to selectively search, filter and/or compile those sub-fields and to recognize those transactions most relevant to the identified action and accounting standard in the received command. Therefore, as is illustrated in FIG. 5, each data field type is a unique transaction and the unique transactions relevant to performing the action are recognized (508). If a data entry has not been received for one or more relevant transactions, an alert indicator is provided that, as a non-limiting embodiment, notifies the end-user that additional data may be required (513).

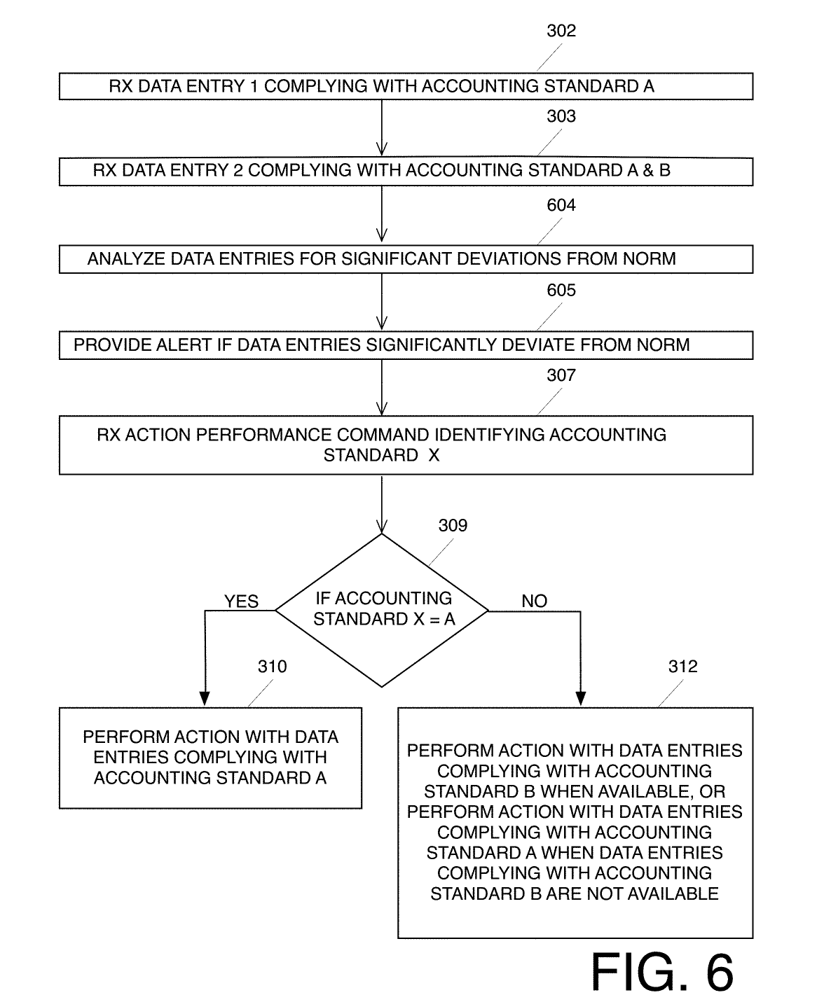

FIG. 6 is a flowchart diagram illustrating actions that may be implemented in some embodiments of the computerized accounting information system, or that may be included within a method of processing accounting data. Specifically, FIG. 6 is the flowchart diagram of FIG. 3 with additional actions.

As is described above, because data entries may be analyzed for significant deviations from what would be expected as a consistent data entry under a particular accounting standard, it is possible to infer/extrapolate/compute this expected data entry based, at least in part, on a sample of related and relevant data entries under similar transactions, or under similar sub-fields across a variety of transactions. Therefore, as is illustrated in FIG. 6, the data entries are analyzed for significant deviations from an expected data entry based, at least in part, on at least one of a group comprising the type of data field, the “A” accounting standard and the “B” accounting standard (604). If the data entries significantly deviate from the expected data entry, an alert indicator is provided (605). Processing of the action may then be halted until the situation is remedied, or the action may continue and the computerized accounting information system may simply flag the data entry as potentially suspect.

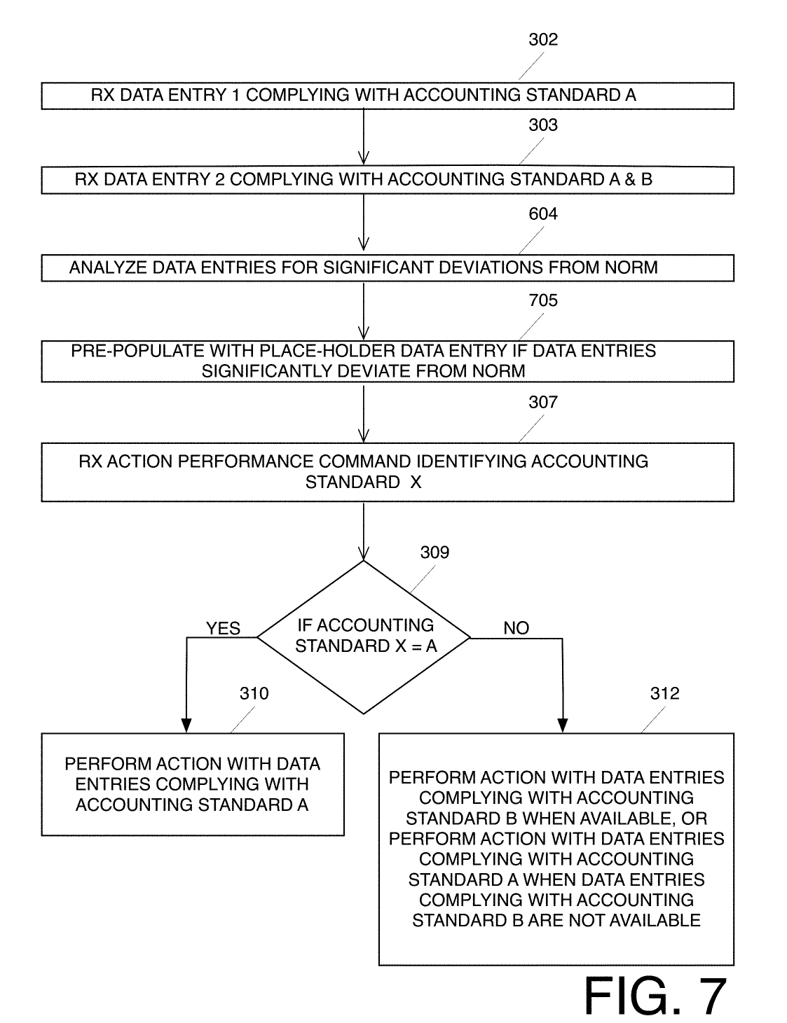

FIG. 7 is a flowchart diagram illustrating actions that may be implemented by the various embodiments of the computerized accounting information system, or that may be included within a method of processing accounting data. Specifically, FIG. 7 is the flowchart diagram of FIG. 6 with an additional action in place of 605.

As described above, instead of merely providing a significant deviation alert indicator, it may be more helpful to leverage the obtained expected data entry such that a specific data entry value suggestion is provided. Therefore, as is illustrated in FIG. 7, if the data entries significantly deviate from the expected data entry, the type of data field may be prepopulated with a place holder data entry (705). In another non-limiting embodiment of FIG. 7, the type of data field is not prepopulated, but instead, emphasized with a suggestion indicator allowing for replacement of any previously entered data entry with the suggested place holder data entry (705). In still another non-limiting embodiment of FIG. 7, the type of data field is only emphasized with a suggestion indicator if the previously entered data entry is sufficiently statistically different from the place holder data entry (705). One having ordinary skill in the art recognizes that the preceding embodiments are merely some of the possible variations available for leveraging the obtained expected data entry such that a specific data entry value suggestion may be provided. Therefore, the various embodiments are not limited to any particular technique.

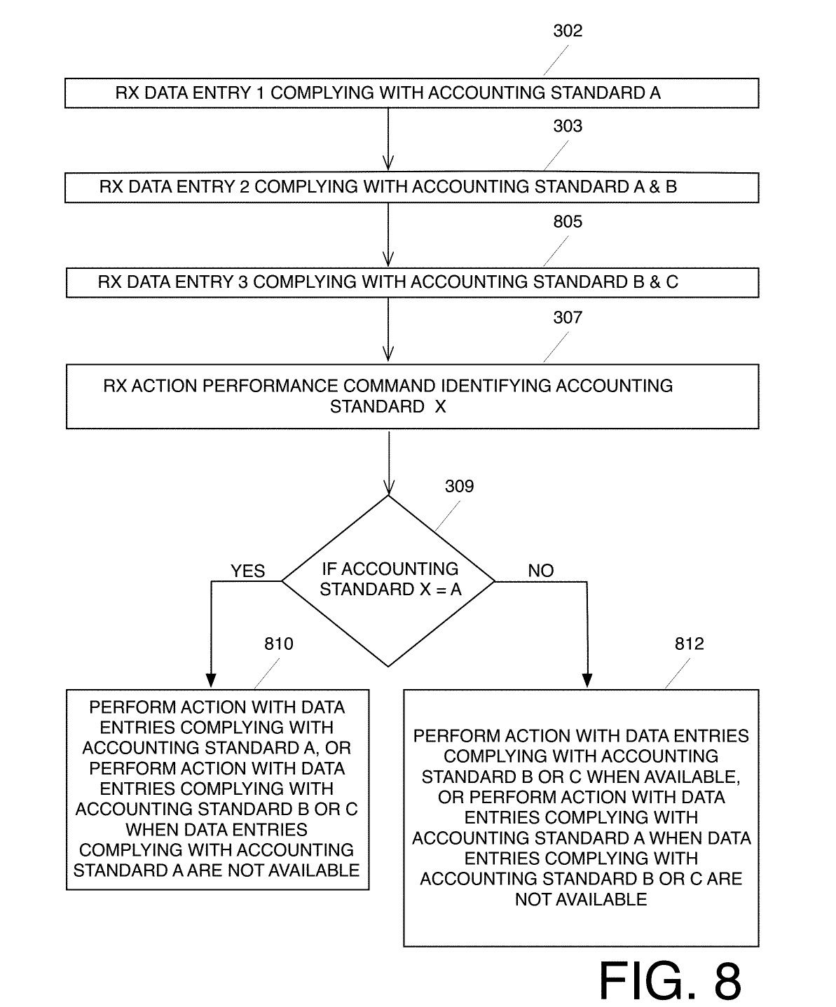

FIG. 8 is a flowchart diagram illustrating actions that may be implemented by the various embodiments of the computerized accounting information system, or that may be included within a method of processing accounting data. Specifically, FIG. 8 is the flowchart diagram of FIG. 3 with additional actions including one in place of 310 and 312.

In the illustrated embodiment, a data entry for a third type of data field is received (805). As is illustrated, this data entry does not comply with the “A” accounting standard; however, it does comply with at least one other accounting standard “B.” Table 3 depicts, as a non-limiting embodiment, how received data entries may be compiled and organized for use based on FIG. 8.

TABLE 3

| Data | Accounting Standard | | |
|---|---|---|---|
| Entry ID | A | B | C |
| 1 | XXX | | |
| 2 | YYY | Y′Y′Y′ | |
| 3 | | Z′Z′Z′ | Z″Z″Z″ |

Therefore, Table 3, in contrast to Table 1, depicts, as a non-limiting embodiment, that a data entry for the ZZZ type of data field was received, and that this data entry complied with the “B” accounting standard and the “C” accounting standard but not the “A” accounting standard.

After the data has been entered into the system, if the identified accounting standard is the “A” accounting standard (309), then the action of the command is performed with one or more data entries that comply with the “A” accounting standard, or, if a data entry is needed for performance of the action but it does not comply with the “A” accounting standard, then data entries complying with any of the other accounting standards is used (810). However, if the identified accounting standard is the “B” accounting standard (309), then the action of the command is performed with one or more data entries that comply with the “B” accounting standard, if available (812). If not available, then the action of the command is performed with one or more data entries that comply with the “A” accounting standard for each of the one or more data entries that is unavailable in the “B” accounting standard (812). If not available, then the action of the command is performed with one or more data entries that comply with the “C” accounting standard for each of the one or more data entries that is unavailable in the “A” accounting standard and the “B” accounting standard (812). Similarly, if the identified accounting standard is the “C” accounting standard (309), then the action of the command is performed with one or more data entries that comply with the “C” accounting standard, if available (812). If not available, then the action of the command is performed with one or more data entries that comply with the “A” accounting standard for each of the one or more data entries that is unavailable in the “C” accounting standard (812). If not available, then the action of the command is performed with one or more data entries that comply with the “C” accounting standard for each of the one or more data entries that is unavailable in the “A” accounting standard and the “C” accounting standard (812).

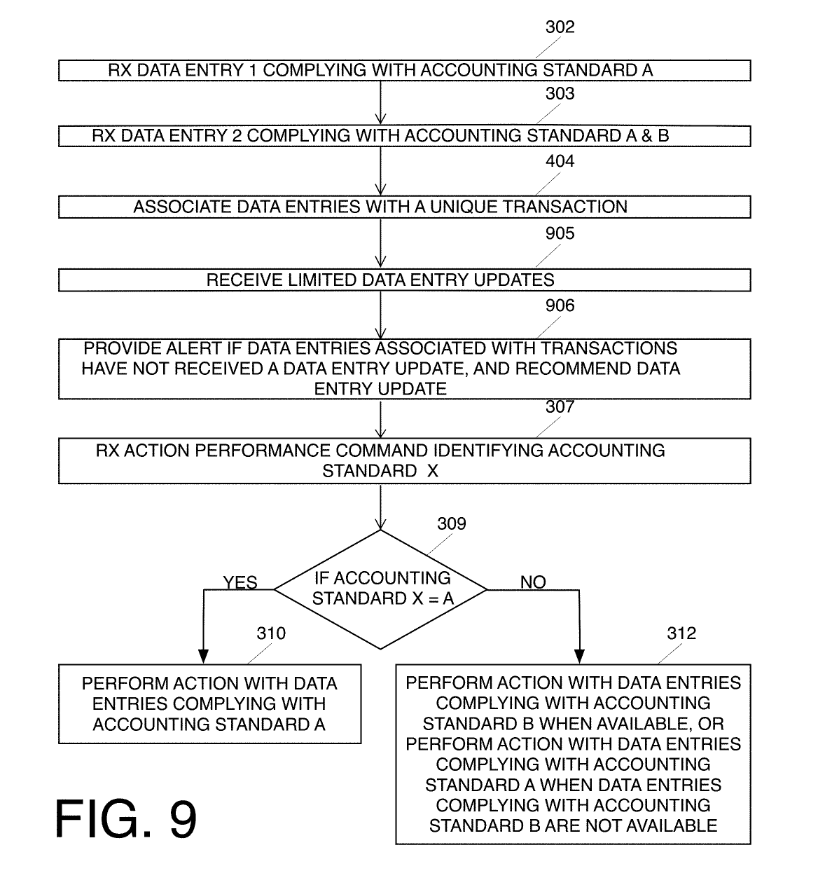

FIG. 9 is a flowchart diagram illustrating actions that may be implemented by the various embodiments of the computerized accounting information system of the present disclosure, or that may be included within a method of processing accounting data. Specifically, FIG. 9 is the flowchart diagram of FIG. 4 with additional actions.

In the illustrated embodiment, at least one limited data entry update for one of the previously received data entries is received (905). The limited data entry updates may comply only with the default accounting standard, “A,” of the previously received data entries or may comply with the “B” accounting standard. These limited data entry updates may fully update an entire unique transaction for either the “A” accounting standard or the “B” accounting standard. On the other hand, these limited data entry updates may simply update sub-components of the unique transactions for either the “A” accounting standard or the “B” accounting standard. Therefore, if any sub-component data entries associated with a unique transaction, or if any entire unique transaction data entry, has not been updated for either the “A” accounting standard or the “B” accounting standard, an alert indicator is provided that recommends further data entry updates (906). Processing of the action may then be halted until the situation is remedied, or the action may continue and the computerized accounting information system may simply flag the data entry as potentially suspect.

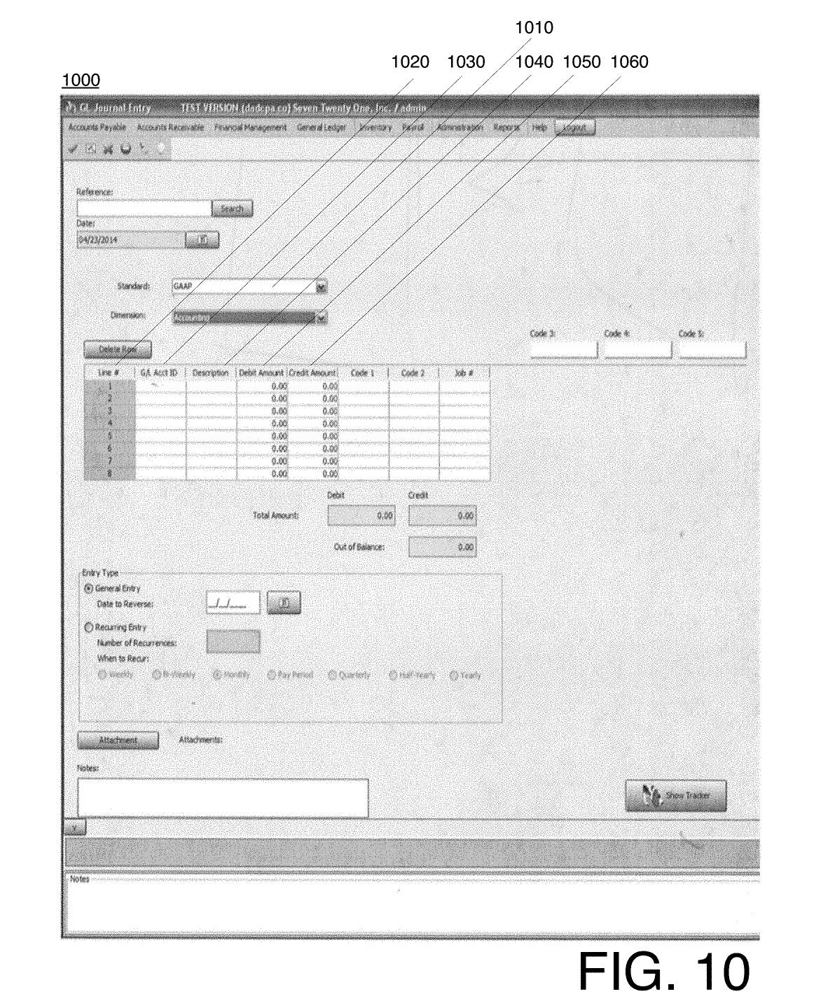

FIG. 10 is a screenshot of one non-limiting embodiment of an end-user interface 1000 to the computerized accounting information system as it might appear to an end-user. The end-user interface 1000 may be incorporated into the data entry module 222, either directly or through the network 220, to receive data entries from the end-user; the data entries to be digitally stored, organized and/or analyzed by computerized accounting information system 200. Therefore, the end-user interface 1000 may appear on the end-user platform 205, as described in FIG. 2, when the end-user platform remotely accesses the data entry module 222 hosted on the platform 100 (e.g., as an online application stored in the cloud, or as a webpage stored on a remote server). The end-user interface 1000 may also appear on the end-user platform 205, as described in FIG. 2, because the data entry module 222 is implemented on the end-user platform 205 as a packaged software bundle, or any downloadable piece of software known to one having ordinary skill in the art. Of course, it is envisioned that the end-user interface 1000 may take various different organizational, graphical and design forms.

In one non-limiting embodiment, the end-user interface 1000 functions, at least in part, as the interface where an end-user enters data entries to be transmitted and received by the data entry module 222 and the processing module 226. The end-user interface 1000 may also function, at least in part, as the interface where an end-user enters a command to be transmitted and received by the command receiving module 224 and the processing module 226. Consequently, the end-user interface 1000 is configured to provide the end-user with the ability to label, categorize and/or organize data entries into fields and to aggregate data entries of different fields into over-arching transactions.

In the illustrated embodiment, the element 1010 represents one non-limiting embodiment of a drop down menu wherein an end-user may select the accounting standard by which the data entries are characterized. The element 1020 represents one column for differentiating the different data entries or the different sub-components of a unique transaction. The element 1030 represents one column for differentiating the different data entries into various unique transactions, or into other grouping categories known to one having ordinary skill in the art. Therefore, the element 1030 represents one embodiment of how a plurality of disparate data entries may be organized and categorized by the end-user. It is with this additional information that the data entries may be leveraged, at least in part, for some of the actions described more thoroughly in FIGS. 3-9.

The element 1040 represents one column for including non-empirical judgment characterization information to be associated and, in certain embodiments, stored with the empirical information that is primarily leveraged by the computerized accounting information system 200. As is described more thoroughly above, financial accounting data may be comprised of empirical information (e.g., monetary values and tax percentages) and non-empirical judgment characterizations related to the accounting standard applied to the accounting data by the end-user. Because an end-user entering data for a specific financial entity must generally follow a specific accounting standard, the same empirical information making up the data entry may be characterized differently by the end-user depending on the particular accounting standard being followed. Therefore, the element 1040 provides an end-user with an information entry point wherein it may record the rational behind the judgment characterizations for each specific data entry under a specific accounting standard at a particular point in time. This may then be readily accessed by the end-user and, in certain embodiments, leveraged by the computerized accounting information system 200 to perform any of the actions described in FIGS. 3-9. As a result, the element 1040 alongside the storing, organizing and analyzing capabilities of the computerized accounting information system 200, may benefits the end-user by substantially eliminating the need for different and discrete data management software records for each accounting standard.

As is understood by one having ordinary skill in the art, the element 1050 and the element 1060 represent standard accounting information data columns for debits and credits to supplant the need for positive and negative integers. Of course, various other columns and organizational elements may be included in the end-user interface 1000. Therefore, the various embodiments are not limited to any particular form or design.

While illustrative embodiments of a computerized accounting information system and a method of processing accounting data have been described in detail herein, it is to be understood that the inventive concepts may be otherwise variously embodied and employed. The appended claims are intended to be construed to include such variations except insofar as limited by the prior art. Possible variations, as described throughout this disclosure, are not to be regarded as a departure from the spirit and scope of the invention. All such possible variations, as would be obvious to one skilled in the art, are intended to be included within the scope of the preceding disclosure and the following claims.

It is understood that any variations of the features of the system and method described in the description section falls within the scope of the invention. There can be many embodiments of this invention as witnessed in some of the figures, and the discussions of them. Not all embodiments of a computerized accounting information system and a method of processing accounting data that would fall within the scope of the claims are necessarily represented here.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In the description and claims the words of the present application, each of “program”, “function” and “module” are used interchangeably. Anything designated as a program, function or module may be a stand-alone entity or a specialized module. A program, function or a module may be modular or have modular aspects allowing it to be easily removed and replaced with another similar unit or module. Each program, function or module may be any one of, or any combination of, software, hardware, and/or firmware. Software of a logical module may be embodied on a computer readable medium such as a read/write hard disc, CDROM, Flash memory, ROM, or other memory or storage, etc. In order to execute a certain task a software program may be loaded to an appropriate processor as needed.

The various embodiments have been described using detailed descriptions of the embodiments, as well as features, aspects, etc. thereof. The various embodiments are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described, and embodiments of the present invention comprising different combinations of features as noted in the described embodiments, will occur to persons with ordinary skill in the art.

It will be appreciated by persons with ordinary skill in the art that the present invention is not limited by what has been particularly shown and described herein above. Rather the scope of the invention is defined by the claims that follow.

What is claimed is:

1. A method of processing accounting data in which individual data entries for a transaction are entered in compliance with a default accounting standard and, optionally, one or more other accounting standards, the method comprising the actions of:
receiving a data entry for a first type of data field, wherein the data entry complies with a default accounting standard;
receiving a data entry for a second type of data field, wherein the data entry complies with the default accounting standard and at least one other accounting standard; and
receiving a command to perform an action, the command identifying an accounting standard;
if the identified accounting standard is the default accounting standard then performing the action utilizing one or more data entries that comply with the default accounting standard; and
if the identified accounting standard is the at least one other accounting standard then performing the action utilizing one or more data entries that comply with the at least one other accounting standard, if available, otherwise utilizing a data entry that complies with the default accounting standard for each of the one or more data entries that is unavailable in the at least one other accounting standard.

2. The method of processing accounting data of claim 1, wherein each data field type is a transaction and the method additionally comprising the action of associating each of the received one or more data entries with a unique transaction.

3. The method of processing accounting data of claim 2, wherein the performance of the action requires at least one transaction.

4. The method of processing accounting data of claim 1, wherein each data field type is a transaction and the method additionally comprising the action of recognizing the transactions relevant to performing the action.

5. The method of processing accounting data of claim 4, the method additionally comprising the action of providing an alert indicator if a data entry has not been received for one or more relevant transactions.

6. The method of processing accounting data of claim 1, the method additionally comprising the action of analyzing the data entries for significant deviations from an expected data entry based, at least in part, on at least one of a group comprising the type of data field, the default accounting standard and the at least one other accounting standard.

7. The method of processing accounting data of claim 6, the method additionally comprising the action of providing an alert indicator if the data entries significantly deviate from the expected data entry.

8. The method of processing accounting data of claim 6, the method additionally comprising the action of prepopulating the type of data field with a place holder data entry if the data entries significantly deviate from the expected data entry.

9. The method of processing accounting data of claim 1, the method additionally comprising the action of:
receiving a data entry for a third type of data field, wherein the data entry complies with the at least one other accounting standard but not the default accounting standard; and
when performing the action, if the identified accounting standard is the default accounting standard then performing the action utilizing one or more data entries that comply with the default accounting standard, if available, otherwise utilizing a data entry that complies with the at least one other accounting standard.

10. The method of processing accounting data of claim 2, the method additionally comprising the action of:
receiving a data entry update, wherein the data entry update complies with only one of a group comprising the default accounting standard and the at least one other accounting standard; and
providing an alert indicator for the data entries associated with the unique transaction but not updated by the data entry update, wherein the alert indicator recommends further data entry updates.

11. The method of processing accounting data of claim 1, wherein the action is at least one of a group comprising generating a report, generating a tax return and generating a financial statement.

12. The method of processing accounting data of claim 2, wherein the transaction is at least one of a group comprising a financial transaction, a business transaction and an accounting transaction.

13. A computerized accounting information system for storing, managing, comparing and reporting financial accounting data entries, wherein the data entries are in compliance with a default accounting standard and, optionally, one or more other accounting standards, the system comprising:
a data entry module;
a command receiving module;
a processing module, communicatively coupled to the data entry module and the command receiving module and configured to:
receive a data entry from the data entry module, the data entry relating to a first transaction and, wherein the data entry complies with a default accounting standard;
receive a data entry from the data entry module, the data entry relating to a second transaction, wherein the data entry complies with the default accounting standard and a non-default accounting standard;
receive a command from the command receiving module, the received command requesting an action to be performed and identifying an accounting standard; and
perform the action based, at least in part, on the identified accounting standard such that:
if the identified accounting standard is the default accounting standard then the processing module utilizes one or more data entries that comply with the default accounting standard; and
if the identified accounting standard is the non-default accounting standard then the processing module utilizes one or more data entries that comply with the non-default accounting standard, if available, otherwise the processing module utilizes data entries that comply with the default accounting standard for each of the one or more data entries that is unavailable in the non-default accounting standard.

14. The computerized accounting information system of claim 13, the processing module additionally configured to recognize a transaction relevant to performing the action.

15. The computerized accounting information system of claim 14, the processing module additionally configured to provide an alert indicator if a data entry has not been received from the data entry module for the relevant transaction.

16. The computerized accounting information system of claim 13, the processing module additionally configured to analyze the data entries for significant deviations from an expected data entry based, at least in part, on at least one of a group comprising the first transaction, the second transaction, the default accounting standard and the at least one other accounting standard.

17. The computerized accounting information system of claim 16, the processing module additionally configured to provide an alert indicator if the data entries significantly deviate from the expected data entry.

18. The computerized accounting information system of claim 16, the processing module additionally configured to prepopulate the type of data field with a place holder data entry if the data entries significantly deviate from the expected data entry.

19. The computerized accounting information system of claim 13, the processing module additionally configured to receive a data entry from the data entry module, the data entry relating to a third transaction, wherein the data entry complies with the at least one other accounting standard but not the default accounting standard.

20. The computerized accounting information system of claim 13, the processing module additionally configured to:
receive a data entry update, wherein the data entry update complies with only one of a group comprising the default accounting standard and the at least one other accounting standard; and
provide an alert indicator for the data entries associated with the same transaction but not updated by the data entry update, wherein the alert indicator recommends further data entry updates.
